(19) United States
(12) Patent Application Publication
(10) Pub. No.: US 2016/0339552 A1
(43) Pub. Date: Nov. 24, 2016

(54) TOOL CARRIER FOR MACHINE TOOL

(71) Applicant: JINN FA MACHINE INDUSTRIAL CO., LTD., CHANGHUA HSIEN (TW)

(72) Inventor: JINN-FA HUANG, CHANGHUA HSIEN (TW)

(21) Appl. No.: 15/017,985

(22) Filed: Feb. 8, 2016

(30) Foreign Application Priority Data
May 21, 2015 (TW) 104207897

(51) Int. Cl. B23Q 3/155; B23Q 1/58

(52) U.S. Cl. CPC B23Q 3/15526; B23Q 1/58

(57) ABSTRACT

A tool carrier for machine tool includes a carrier base mounted in a machine tool, the carder base including a first sliding rail and a second sliding rail being of different levels of elevation, and defining a sliding direction along which the first and second sliding rail; the first sliding rail defining a first rail surface, and the second sliding rail defining a second rail surface; wherein the first rail surface defines a first normal line, and the second rail surface defines a second normal line; the first and second normal lines are relative to each other in a non-perpendicular relationship; the first and second rail surfaces parallel to the horizontal plane; and a sliding carriage slidably coupled to the first sliding rail and the second sliding rail and moving relatively to the carrier base. Thus, the tool carrier effectively improves the load capacity.

### BACKGROUND OF THE INVENTION

1. Field of the Invention

The present invention relates to machine tool technology, and more particularly to a tool carrier for machine tool.

2. Description of the Related Art

Conventional machine tools have different names and different applications according to their processing methods. The most common machine tools are lathes, milling machines and turn-mill machine tools, etc. With the use of computer numerical control function, machine tools are capable of performing precision machining repeatedly and automatically, reducing the machining cost and improving the machining reliability. Further, in order for enabling a machine tool to achieve multiplex machining, the machine tool will be equipped with multiple turret units and main shaft units to mate with a sliding carriage for application. By means of the mobility characteristics of the sliding carriage, the turret units and main shaft units can be selectively arranged into various combinations, thereby reducing secondary machining processes and increasing the added value of the machine tool.

However, with the upgrading of the processing function, the number of cutting tools (such as lathing tools, milling tools, or drill bits) at the turret unit and the number of driving sources are relatively increased. At this time, the load capacity of the sliding carriage for carrying the turret units and the driving sources, its sliding smoothness and machining stability can affect the precision of the machine tool.

The sliding carriage of a conventional machine tool is coupled to the carrier base through two sliding rails. These two sliding rails are arranged in parallel. The rail surface of one sliding rail is disposed in parallel to the horizontal plane. The rail surface of the other sliding rail is disposed perpendicular to the horizontal plane. Thus, the two sliding rails are arranged at right angles. However, in order to facilitate machining, the tools are disposed to protrude over the outer edge of the sliding carriage so that the sliding carriage can have a rotational torque relative to the carrier base, i.e., the two sliding rails must bear normal forces as well as lateral forces, lowering the sliding smoothness of the sliding carriage and the machining stability of the turret units. An improvement in this regard is desired.

### SUMMARY OF THE INVENTION

The present invention has been accomplished under the circumstances in view. It is the main object of the present invention to provide a tool carrier for machine tool, which provides better load capacity when compared to conventional tool carrier designs.

To achieve this and other objects of the present invention, a tool carrier for machine tool settled on a horizontal plane, and the tool carrier comprises a carrier base and a sliding carriage. The carrier base is mounted in the machine tool, including a first sliding rail and a. second sliding rail being of different levels of elevation, and defining a sliding direction along which the first and second sliding rail. Further, the first sliding rail defines a first rail surface, and the second sliding rail defines a second rail surface, wherein the first rail surface defines a first normal line, and the second rail surface defines a second normal line. The horizontal plane defines a third normal line. The first and second normal lines are relative to each other in a non-perpendicular relationship. The first and second normal lines parallel to the third normal line in a non-concomitant manner. The sliding carriage is slidably coupled to the first and second sliding rails and moves relatively to the carrier base.

The relative arrangement between the first sliding rail and the second sliding rail greatly improves the load capacity of the carrier base relative to the sliding carriage.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a tool carrier for a machine tool in accordance with a first embodiment of the present invention.

FIG. 2 is a side view of the tool carrier in accordance with the first embodiment of the present invention.

FIG. 3 is a side view of a tool carrier in accordance with a second embodiment of the present invention.

FIG. 4 is a side view of a tool carrier in accordance with a third embodiment of the present invention.

### DETAILED DESCRIPTION OF THE INVENTION

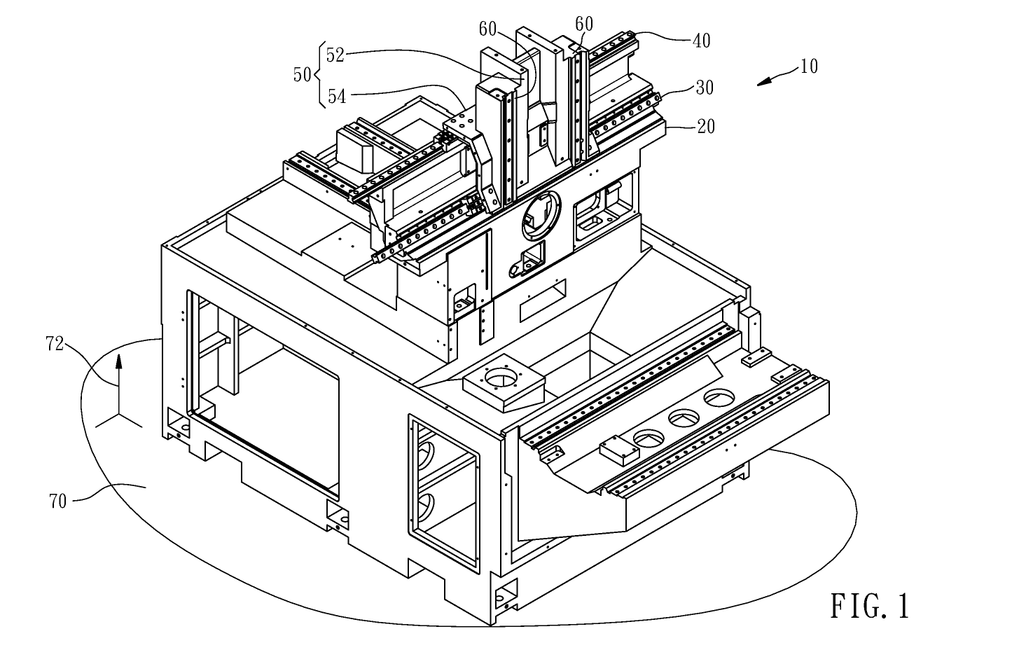

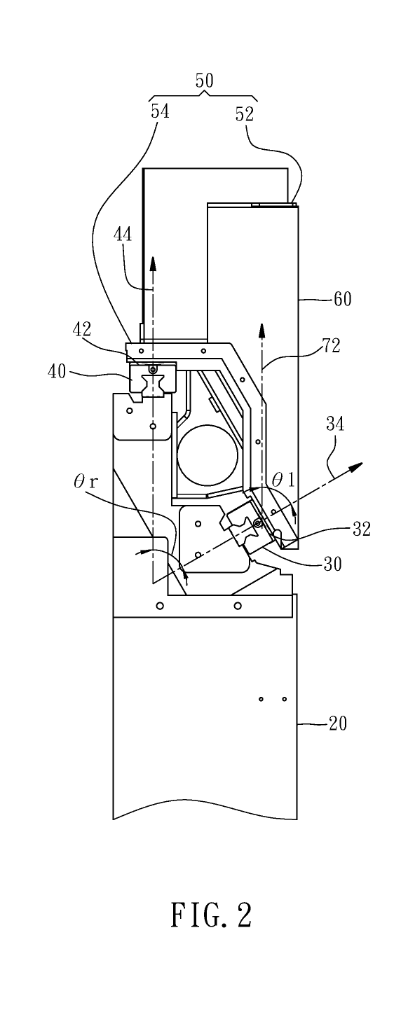

Referring to FIGS. 1 and 2, a tool carrier 10 in accordance with a first embodiment of the present invention is shown. As illustrated, the tool carrier 10 for machine tool settled on a horizontal plane 70, and the tool carrier 10 comprises a carrier base 20, a first sliding rail 30, a second sliding rail 40, a sliding carriage 50 and a turret unit (not shown).

The carrier base 20 is mounted in the machine tool, including the first sliding rail 30 and the second sliding rail 40 being of different levels of elevation, and defining a sliding direction along which the first and second sliding rail. The first sliding rail 30 defines a first rail surface 32, and the second sliding rail 40 defines a second rail surface 42, wherein the first rail surface 32 defines a first normal line 34 perpendicular thereto, and the second rail surface 42 defines a second normal lines 44 perpendicular thereto. The horizontal plane 70 defines a third normal line 72 perpendicular thereto. The first and second normal lines 34, 44 are relative to each other in a non-perpendicular relationship. The first and second normal lines 34, 44 parallel to the third normal line 72 in a non-concomitant manner.

The sliding carriage 50 is slidably coupled to first sliding rail 30 and the second sliding rail 40 and moves relatively to the carrier base 20. The sliding carriage 50 includes a carrying portion 52 located at a front side thereof and an abutment portion 54 located at a rear side opposite to the front side, and two carrying rails 60 located at the carrying portion 52. The turret unit is slidably coupled to the two carrying rails 60 and movable relative to the carrying portion 52 of the sliding carriage 50.

The first sliding rail 30 is connected to a front side of the abutment portion 54 of the sliding carriage 50. The second sliding rail 40 is connected to a rear side, opposite to the front side, of the abutment portion 54 of the sliding carriage 50. Further, the level of elevation of the first sliding rail 30 is lower than the level of elevation of the second sliding rail 40.

The tool carrier 10 further has a first contained angle θ1 defined between the first normal line 34 of the first sliding rail 30 and the third normal line 72 of the horizontal plane 70, wherein the first contained angle θ1 is ≧55° and ≦65°. Besides, the tool carrier 10 further has a relative contained angle θr defined between the first normal line 34 of the first sliding rail 30 and the second normal line 44 of the second sliding rail 40, wherein the relative angle θr is <90°. In this first embodiment, the second normal line 44 of the second sliding rail 40 substantially parallels with the third normal line 72 of the horizontal plane 70.

After described the structural details of the first embodiment of the present invention, the effects of this first embodiment is outlined hereinafter.

By means of changing the arrangement of the first sliding rail 30 and the second sliding rail 40, the load capacity of the carrier base 20 relative to the sliding carriage 50 can be increased, improving the sliding smoothness of the sliding carriage 50, enhancing the operating stability of the turret unit and prolonging the lifespan of the tool carrier 10.

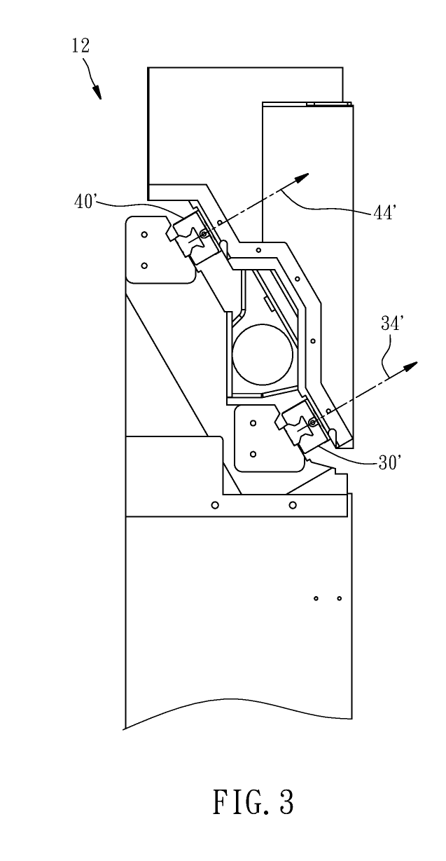

Referring to FIG. 3, a tool carrier 12 for machine tool in accordance with a second embodiment of the present invention is shown. This second embodiment is substantially similar to the aforesaid first embodiment with the exception that: the first normal line 34′ of the first sliding rail 30′ substantially parallels to the second normal line 44′ of the second sliding rail 40′.

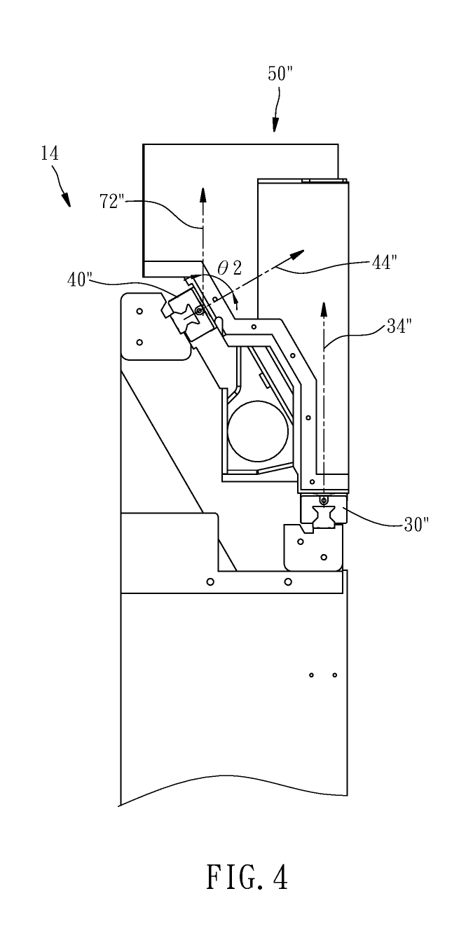

Referring to FIG. 4, a tool carrier 14 for machine tool in accordance with a third embodiment of the present invention is shown. This third embodiment is substantially similar to the aforesaid first embodiment with the exception that: the tool carrier 10″ further has a second contained angle θ2 defined between the second normal line 44″ of the second sliding rail 40″ and the third normal line 72″ of the horizontal plane (not shown), wherein the second contained angle θ2 is ≧55° and ≦65°; the first normal line 34″ of the first sliding rail 30″ substantially parallels to the third normal line 72″ of the horizontal plane (not shown).

The other structural details of the second and third embodiments and the effects they can achieve are same as the aforesaid first embodiment, and therefore, no further description in this regard will be given.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool carrier for machine tool settled on a horizontal plane, and the tool carrier comprising:
a carrier base mounted in the machine tool, including a first sliding rail and a second sliding rail being of different levels of elevation, and defining a sliding direction along which the first and second sliding rail; said first sliding rail defining a first rail surface, and said second sliding rail defining a second rail surface; wherein said first rail surface defines a first normal line, and said second rail surface defines a second normal line; said horizontal plane defines a third normal line; said first and second normal lines are relative to each other in a non-perpendicular relationship; said first and second normal lines parallel to said third normal line in a non-concomitant manner; and
a sliding carriage slidably coupled to said first and second sliding rails and moving relatively to said carrier base.

2. The tool carrier for machine tool as claimed in claim 1, wherein said sliding carriage includes a carrying portion located at a front side thereof and an abutment portion located at a rear side opposite to the front side, said abutment portion connects to said first sliding rail and said second sliding rail.

3. The tool carrier for machine tool as claimed in claim 2, wherein said first sliding rail is connected to a front side of said abutment portion of said sliding carriage; said second sliding rail is connected to a rear side, opposite to the front side, of said abutment portion of said sliding carriage; the level of elevation of said first sliding rail is lower than the level of elevation of said second sliding rail.

4. The tool carrier for machine tool as claimed in claim 3, further having a first contained angle θ1 defined between said first normal line of said first sliding rail and said third normal line of said horizontal plane, wherein the first contained angle θ1 is ≧55° and ≦65°.

5. The tool carrier for machine tool as claimed in claim 4, further having a. relative contained angle θr defined between said first normal line of said first sliding rail and said second normal line of said second sliding rail wherein said relative angle θr is <90°.

6. The tool carrier for machine tool as claimed in claim 5, wherein said second normal line of said second sliding rail substantially parallels with said third normal line of said horizontal plane.

7. The tool carrier for machine tool as claimed in claim 5, wherein said first normal line of said first sliding rail substantially parallels to said second normal line of said second sliding rail.

8. The tool carrier for machine tool as claimed in claim 3, further having a second contained angle θ2 defined between said second normal line of said second sliding rail and said third normal line of said horizontal plane, wherein the second contained angle θ2 is ≧55° and ≦65°.

9. The tool carrier for machine tool as claimed in claim 8, wherein said first normal line of said first sliding rail substantially parallels to said third normal line of said horizontal plane.

10. The tool carrier for machine tool as claimed in claim 2, wherein said sliding carriage further includes two carrying rails located at said carrying portion.
